(19) United States
(12) Patent Application Publication
(10) Pub. No.: US 2014/0195685 A1
(43) Pub. Date: Jul. 10, 2014

(54) SYSTEM AND METHOD FOR SESSION CONTROL IN CONVERGED NETWORKS

(71) Applicant: FMR LLC, Boston, MA (US)

(72) Inventor: Richard Lee, North Providence, RI (US)

(73) Assignee: FMR LLC, Boston, MA (US)

(21) Appl. No.: 13/735,352

(22) Filed: Jan. 7, 2013

(51) Int. Cl. H04L 29/06

(52) U.S. Cl. CPC H04L 65/1066
USPC 709/226

(57) ABSTRACT

A system for managing network information is provided that includes a policy database that defines handling both application and network resources in both a network space and an application space. A queue control program (QCP) manages both application and network resources in the application. The QCP queries the policy database to retrieve a selective rule associated with managing network congestion due in part by execution of an application or network resource.

### BACKGROUND OF THE INVENTION

The invention is related to the field of multimedia network applications, and in particular to a queue control proxy (QCP) that utilizes feedback of network information.

Multimedia application proxies, registrars and gateways “setup” sessions on IP networks and manage media for endpoints. These work exclusively in the application domain Network devices such as switches and routers forward and drop packets from queues from physical interfaces based on port configuration settings to address congestion. These work exclusively in the network domain and do not necessarily correct session quality problems. In fact, it may cause it periodically to get worse. SDN's are a new technology that promises to abstract the control plane of network devices to apply logic for control of application flows (i.e. dynamic increase in priority queue). These also work in the network domain. Edge proxies such as SBC's which admit application flows based on application rules and device capacity. These work in the application domain typically used for security. Unified Communications devices such as signaling and media proxies also work in the application domain.

### SUMMARY OF THE INVENTION

According to one aspect of the invention, there is provided a system for managing network information. The system includes a policy database that defines handling both application and network resources in both a network space and an application space. A queue control program (QCP) manages both application and network resources in the application. The QCP queries the policy database to retrieve a selective rule associated with managing network congestion due in part by execution of an application or network resource.

According to another aspect of the invention, there is provided a method of managing network information. The method includes defining rules for handling both application and network resources in both a network space and an application space using a policy database. Also, the method includes managing both application and network resources in the application space using a query control program (QCP). The QCP queries the policy database to retrieve a selective rule associated with managing network congestion due in part by execution of an application or network resource.

### BRIEF DESCRIPTION OF THE DRAWINGS

FIG. 1 is a schematic diagram illustrating a network environment using the inventive queue control proxy (QCP) in a network system; and

FIG. 2 is a process flow illustrating an example of how the QCP manages traffic and resources for executing a video application.

### DETAILED DESCRIPTION OF THE INVENTION

The invention involves a queue control proxy (QCP) that utilizes feedback of network information and a rules based database for application control of network utilization including changes to bandwidth, encoding, format, codecs used for sessions as well as other measures up to and including terminating sessions based on rules associated with a rules based database (Application Control Authority Database).

Many different application servers controlling multimedia sessions leverage the same ports and queues in the network. The network addresses congestion via packet drops from queues. There is no application-based communications between the network and applications in the prior art for actions to be taken in the event of congestion; especially when there are scheduled events which may create congestion. All traffic leveraging the same queues are weighted at the same priority. There is no policy-based mechanism to address both network and application actions for service delivery in the prior art.

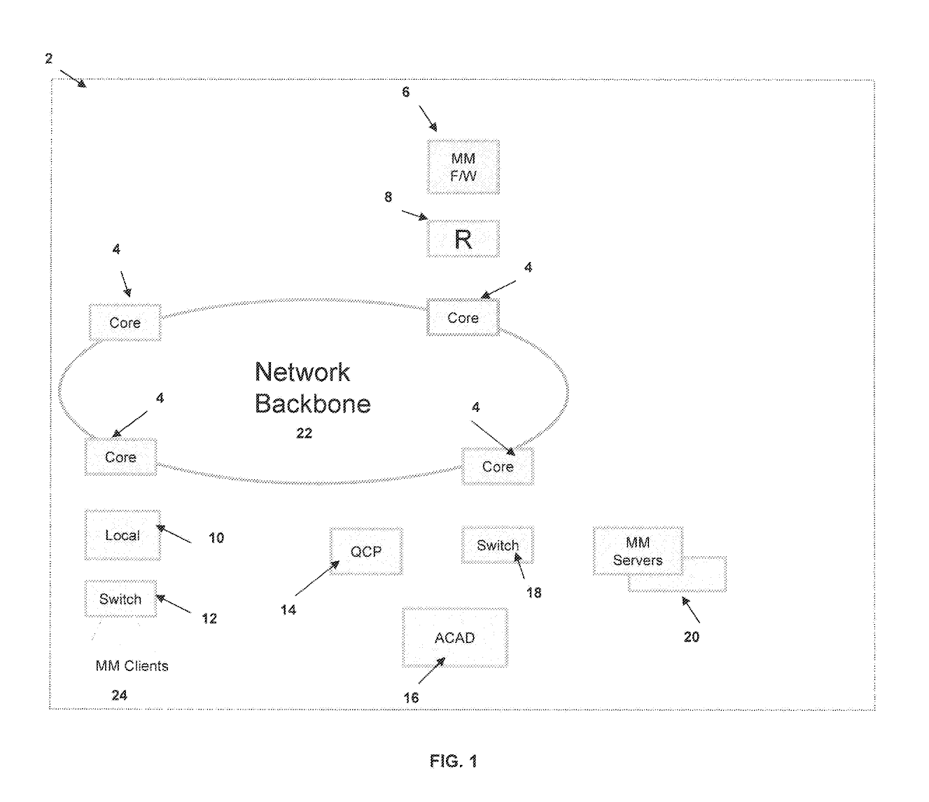

FIG. 1 is a schematic diagram illustrating the network environment using the inventive QCP 14 in a network system 2. A router 8 is provided that forwards data packets from a multimedia (MM) server 6, creating an overlay network. The router 8 can be connected to two or more data lines from different networks. When a data packet comes in one of the lines, the router 8 reads the address information in the packet to determine its ultimate destination. Then, using information in its routing table or routing policy, it directs the packet to the next network on its journey. Routers perform the “traffic directing” functions in a network. A data packet is typically forwarded from one router to another through the networks until it gets to its destination node. The network 2 can include a network backbone 22 that interconnects various pieces of the network, providing a path for the exchange of information between different LANs or subnetworks. The network backbone 22 can tie together diverse networks in the same location or remote locations. Normally, the network backbone's 22 capacity is greater than the networks connected to it.

A large corporation that has many locations can have a network backbone 22 that ties all of the locations together, for example, a network backbone 22 can make a server cluster accessible by different departments of a company that are located at different geographical locations. Network congestion is often taken into consideration while designing network backbones. The network backbone 22 can include core routers 4 interconnecting multiple locations or large enterprise locations to a local router 10. The network backbone 22 are optimized for high bandwidth.

A network switch 12 links information from the local router 10 to network devices, such as the multimedia (MM) clients 24. The local router 10 transfers data between a local area network and a wide area network, choosing the most effective paths to use when sending or receiving data. In this case, the local network includes the MM clients 24 via a network switch 12.

The queue control proxy (QCP) 14 acts on both network and application information in the application space. This could include session quality packet metrics (latency, jitter, packet loss, bursts) for non-deterministic traffic requiring some priority, such as video over IP. The QCP 14 can communicate with applications via application signaling protocols to the originating proxies or gateways to address control of traffic in network queues. The QCP 14 queries an Application Control Authority Database (ACAD) 16 for application traffic policies. Each application that has “rights” defined in the ACAD can send traffic to a given queue. Rights identify attributes including priority within traffic type, whether to drop a packet, an individual session or group of sessions, or whether to change media attributes (type, bandwidth, . . . ) for a session or group of sessions. The QCP 14 can act as the application interface for SDNs to enforce policies requiring application signaling to modify session characteristics. Multimedia Servers 20 can utilize the QCP as an edge device for admission and prioritized session control. The multimedia servers 20 communicate with the QCP 14 via the network backbone 22 and network switch 18. Note the QCP 14 uses the network switch receiving information about applications as well as directly managing network resources using the network switch 18.

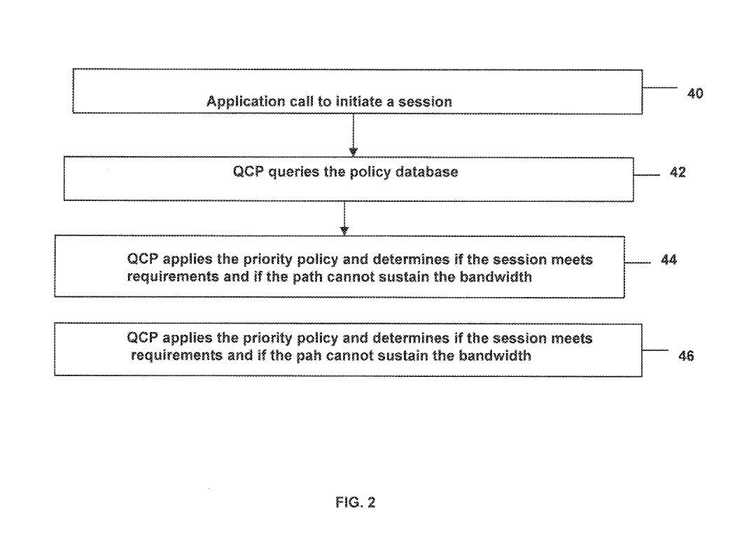

FIG. 2 is a process flow illustrating an example of how the QCP manages traffic and resources for executing a video application. One of the first things accomplished by the invention is session initiation produced in part by an application making an application call to create a session invite, as shown in step 40. As an example, a video server can check the local policy and capacity to determine if the new session meets requirements. The video server can send a session invite with audio/video requirements to the QCP. When the QCP receives the session invite, it queries the policy database stored in the ACAD, as shown in step 42. The QCP applies the priority policy and determines if the session meets requirements and if the path cannot sustain the bandwidth, as shown in step 44. The QCP applies the congestion policy and takes appropriate action by either dropping a session, dropping existing session, or letting the network drop packets as congestion is encountered, as shown in step 46. Also, the QCP can reset bandwidth allocations for one or more existing sessions to accommodate a new session. The QCP notifies a selected server whose sessions are affected.

Note the QCP can work directly with applications as well as network resources such as servers, routers, core routers, network switches, or the like, to control network congestion. Moreover, ACAD can include policies used by the QCP that can control network resources as well as application resources simultaneously. The QCP can be an application program that is being stored and executed on a client or server in network environment.

Moreover, the invention can be used in addressing distributed denial-of-service attack (DDoS attack). A DDoS attack is an attempt to make a machine or network resource unavailable to its intended users. Although the means to carry out, motives for, and targets of a DDoS attack may vary, it generally consists of the efforts of one or more people to temporarily or indefinitely interrupt or suspend services of a host connected to the Internet. Once a DDoS attack is encountered the QCP can be called upon to manage and control the congestion produced by the DDoS attacks. ACAD includes specific rules for the QCP to implement in managing and protecting valuable network resources.

Also, network-based agents can rely on the invention to monitor and report on the status of the network. Many network-based agents are often used to monitor complex computer networks to predict when a crash or some other defect can occur. Other types of network-based agents work on computer networks keeping track of the configuration of each computer connected to the network. These agents track and update the central configuration database when anything on any computer changes, such as the number or type of disk drives. An important task in managing networks lies in prioritizing traffic and shaping bandwidth, thus a network-based agent can use the QCP to aid in prioritizing traffic and shaping bandwidth without producing significant hindrance in the network's performance.

This invention proposes a queue control proxy (QCP) that utilizes feedback of network information and a rules based database for application control of network utilization including changes to bandwidth, encoding, format, codecs used for sessions as well as other measures up to and including terminating sessions based on rules associated with a rules based database. Moreover, the invention can manage the resources of both network and application information in the application space. This could include session quality packet metrics (latency, jitter, packet loss, bursts) for nondeterministic traffic requiring some priority.

Although the present invention has been shown and described with respect to several preferred embodiments thereof, various changes, omissions and additions to the form and detail thereof, may be made therein, without departing from the spirit and scope of the invention.

What is claimed is:

1. A system for managing network information comprising:
a policy database stored in network memory that defines handling both application and network resources in both a network space and an application space; and
a queue control program (QCP) executing on a processor in a network that simultaneously manages said both application and network resources in the application, wherein a session initiation is produced by an application making an application call to create a session invite received by the QCP, wherein the QCP queries the policy database to retrieve a selective rule associated with managing network congestion due in part by execution of an application or network resource, wherein the QCP performs selective operations as indicated in the selective rule for reducing network congestion by actively engaging with application and network resources.

2. The system of claim 1, wherein the application resources comprise rights that are defined in the policy database.

3. The system of claim 2, wherein the rights identify attributes including priority within traffic type, whether to drop a packet, an individual session or group of sessions, or whether to change media attributes.

4. The system of claim 1, wherein the QCP communicates with applications via application signaling protocols to originating proxies or gateways to address control traffic in network queues.

5. The system of claim 1, wherein the QCP enforces policies requiring application signaling to modify session characteristics.

6. The system of claim 1, wherein the QCP determines if a session meets requirements and if the path cannot sustain the bandwidth.

7. The system of claim 1, wherein the QCP applies a congestion policy and takes appropriate action by either dropping a session, dropping an existing session, or letting the network drop packets as congestion is encountered.

8. The system of claim 1, wherein the QCP resets bandwidth allocations for one or more existing sessions to accommodate a new session.

9. The system of claim 8, wherein the QCP notifies a selected server whose sessions are affected.

10. The system of claim 1, wherein the QCP aids in managing the network resources when the network is under a distributed denial-of-service attack (DDoS attack).

11. The system of claim 1, wherein the QCP aids a network agent in managing the network resources.

12. A method of managing network information comprising:
defining rules for handling both application and network resources in both a network space and an application space using a policy database; and
simultaneously managing both application and network resources in the application space using a query control program (QCP), wherein a session initiation is produced by an application making an application call to create a session invite received by the QCP, the QCP querying the policy database to retrieve a selective rule associated with managing network congestion due in part by execution of an application or network resource, wherein the QCP performs selective operations as indicated in the selective rule for reducing network congestion by actively engaging with application and network resources.

13. The method of claim 12, wherein the application resources comprise rights that are defined in the policy database.

14. The method of claim 13, wherein the rights identify attributes including priority within traffic type, whether to drop a packet, an individual session or group of sessions, or whether to change media attributes.

15. The method of claim 12, wherein the QCP communicates with applications via application signaling protocols to originating proxies or gateways to address control traffic in network queues.

16. The method of claim 12, wherein the QCP enforces policies requiring application signaling to modify session characteristics.

17. The method of claim 12, wherein the QCP determines if a session meets requirements and if the path cannot sustain the bandwidth.

18. The method of claim 12, wherein the QCP applies a congestion policy and takes appropriate action by either dropping a session, dropping an existing session, or letting the network drop packets as congestion is encountered.

19. The method of claim 12, wherein the QCP resets bandwidth allocations for one or more existing sessions to accommodate a new session.

20. The method of claim 19, wherein the QCP notifies a selected server whose sessions are affected.

21. The method of claim 12, wherein the QCP aids in managing the network resources when the network is under a distributed denial-of-service attack (DDoS attack).

22. The method of claim 12, wherein the QCP aids a network agent in managing the network resources.
